(19) United States
(12) Patent Application Publication
(10) Pub. No.: US 2008/0019129 A1
(43) Pub. Date: Jan. 24, 2008

(54) LED Lamp Illumination Projecting Structure

(76) Inventor: Chin-Wen Wang, Pingzhen City (TW)

Correspondence Address: HDSL, 4331 STEVENS BATTLE LANE, FAIRFAX, VA, 22033, US

(21) Appl. No.: 11/459,496

(22) Filed: Jul. 24, 2006

(51) Int. Cl. F21V 5/04

(52) U.S. Cl. 362/244; 362/336

(57) ABSTRACT

In an LED lamp illumination projecting structure, an LED lamp includes a casing, an LED lamp set and a light transmitting lens. The casing has an LED lamp set with a base board mounted in the casing and several LED lamp connected to the base board, and the light transmitting lens is installed in the light projecting direction of the LED lamp set and sealed onto a side of the casing, and several pits arranged with an interval apart and formed on the internal surface at a position corresponding to the projected position of each LED lamp for collecting and emitting the light of each LED lamp through the pit, so as to provide a better directionality of the light of the LED lamp and an evener brightness for a projecting area.

### BACKGROUND OF THE INVENTION

1. Field of the Invention

The present invention relates to an LED lamp illumination projecting structure, and more particularly to an LED lamp illumination projecting structure capable of improving the directionality of the light and providing an even brightness of the LED lamp.

2. Description of Prior Art

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness.

A traditional LED lamp illumination projecting structure includes a casing, an LED lamp set and a light transmitting lens. The light transmitting lens and the casing are engaged with each other to form a containing space between the two for installing an LED lamp set. The LED lamp set includes a base board fixed in the casing and a plurality of LED lamps fixed onto the bottom surface of the base board, and each LED lamp is installed at a corresponding side of the light transmitting lens, such that the light emitted from an LED bulb in each LED lamp is projected to the outside through the light transmitting lens. Since the light transmitting lens does not come with the pits corresponding to the projecting position of each LED lamp, the LED lamp has a poor directionality of light and an uneven brightness in the projecting area. The foregoing shortcomings require improvements.

### SUMMARY OF THE INVENTION

In view of the foregoing shortcomings of the prior art, the inventor of the present invention based on years of experience in the related industry to conduct experiments and modifications, and finally designed an LED lamp illumination projecting structure to overcome the shortcomings of the prior art.

Therefore, the present invention is to overcome the shortcomings of the prior art by providing an LED lamp illumination projecting structure that includes a pit disposed on the internal surface of the light transmitting lens and corresponding to the LED lamp, so as to provide a good directionality of light for each LED lamp and an even brightness in the projecting area.

The present invention provides an LED lamp illumination projecting structure comprising a casing, an LED lamp set and a light transmitting lens, wherein the LED lamp set installed in the casing includes a base board installed in the casing and a plurality of LED lamps connected to the base board, and the light transmitting lens is sealed onto a side of the casing at the corresponding projecting direction of the LED lamp set, and a plurality of pits arranged with an interval from each other and formed downward on the internal side of the light transmitting lens and disposed at a position corresponding to each LED lamp for emitting the light of each LED lamp through the pits, after the light is gathered.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a light transmitting lens of the present invention;

FIG. 2 is a cross-sectional view of a light transmitting lens of the present invention;

FIG. 3 is an exploded view of an LED lamp of the present invention;

FIG. 4 is a cross-sectional view of an LED lamp of the present invention; and

FIG. 5 is a cross-sectional view of an application of an LED of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

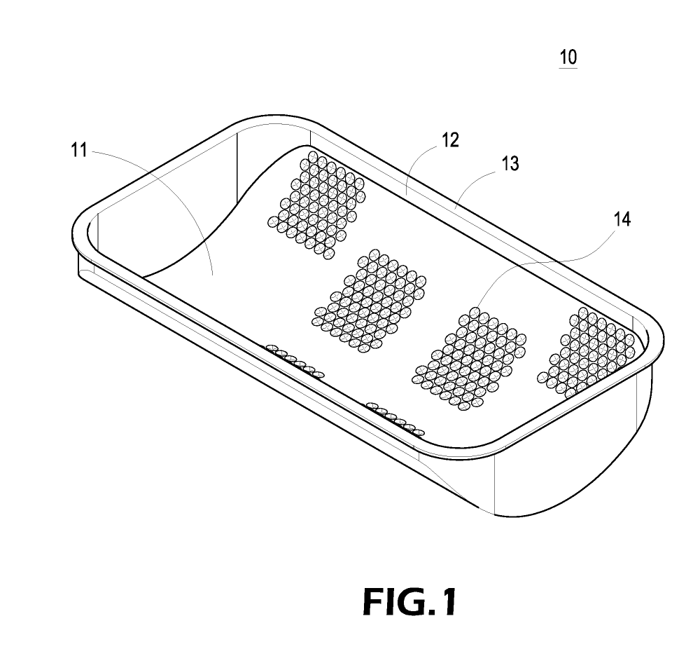

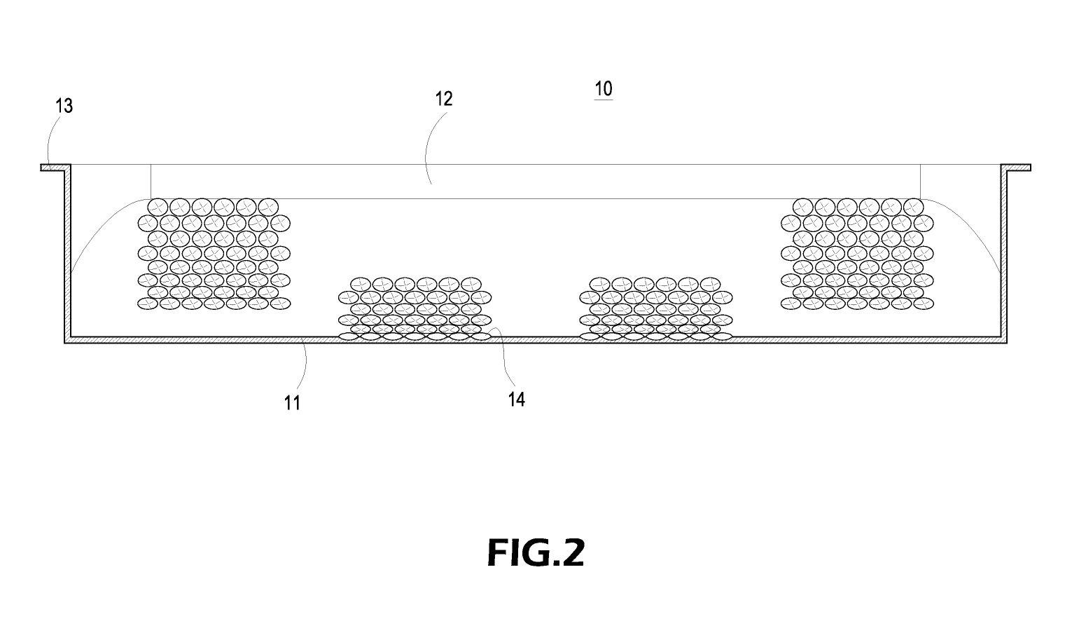

Referring to FIGS. 1 and 2 for the perspective view and cross-sectional view of a light transmitting lens in accordance with the present invention, an LED lamp illumination projecting structure is provided. The light transmitting lens 10 is made of a transparent material or a semi-transparent material, and the light transmitting lens 10 is comprised of a rectangular arc bottom panel 11, a surrounding panel 12 extended vertically upward from the periphery of the bottom panel 11, a flange 13 extended horizontally from the periphery of the top of the surrounding panel 12, and a plurality of concavely downward hemispherical pits 14 disposed on the internal surface of the bottom panel 11 and arranged with an interval with each other.

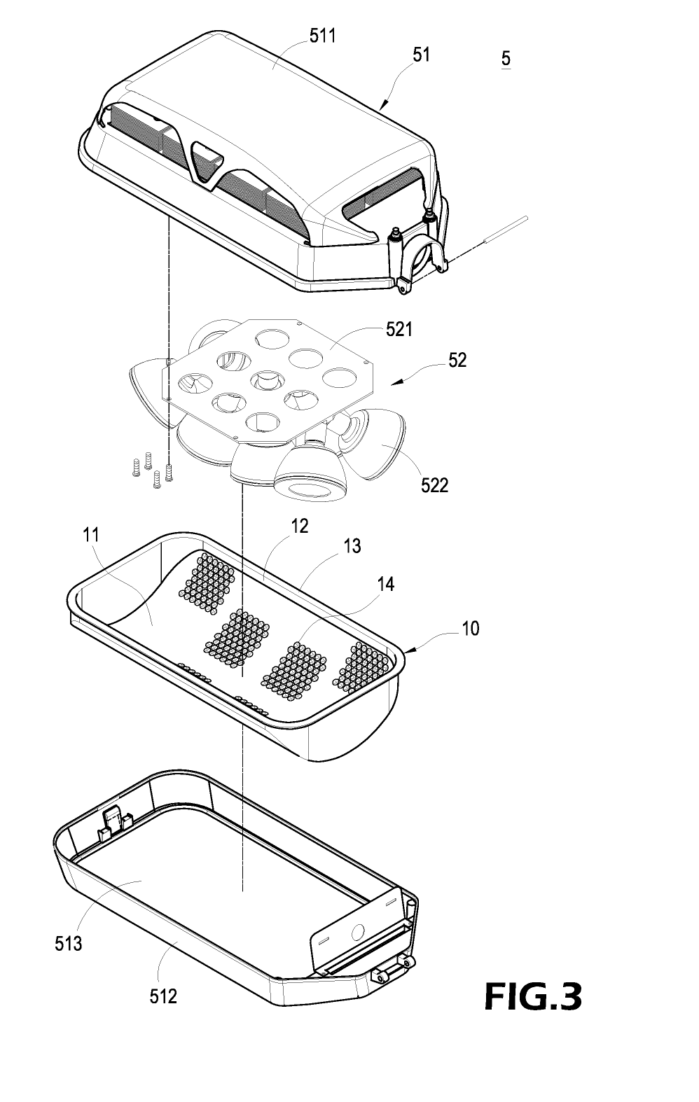

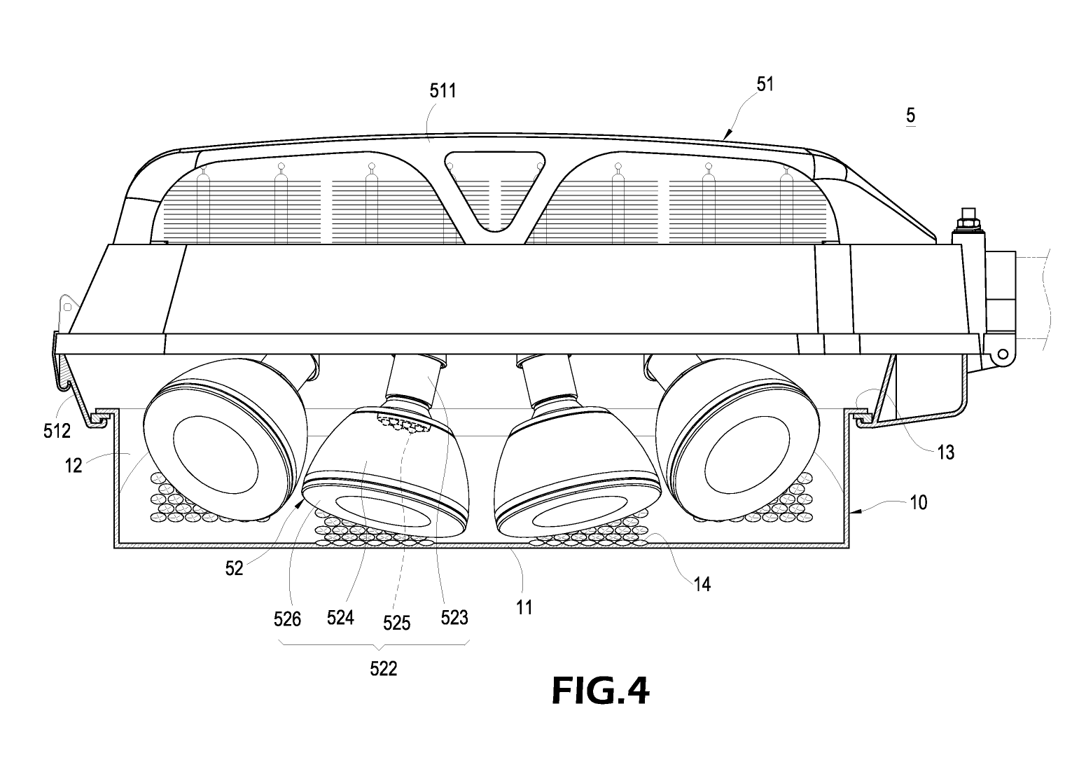

Referring to FIGS. 3 and 4 for the exploded view and cross-sectional view of the LED lamp set in accordance with the present invention, the light transmitting lens 10 is installed onto the LED lamp set 5, and the LED lamp set 5 includes a casing 51 and an LED lamp set 52, wherein the casing 51 includes an upper casing panel 511, a lower frame 521 coupled to the bottom of the upper casing panel 511, and a hollow slot 513, formed at the middle of the lower frame 512 for mounting the light transmitting lens 10. The flange 13 of the light transmitting lens 10 is attached to the internal bent edge of the lower frame 512, and a containing space is formed between the upper casing panel 511 and the light transmitting lens 10 for installing the LED lamp set 52. The LED lamp set 52 includes a base board 521 connected to the casing 511 by a fixture such as a screw, and a plurality of LED lamps 522 coupled at the bottom of the base board 521. Each LED lamp 522 is connected to the reflecting hood 524 of the lamp holder 523 by a lamp holder 523, and a plurality of LED bulbs 525 are installed in the reflecting hood 524, and a lens 526 sealed onto the bottom surface of the reflecting hood 524 (as shown in FIG. 4). Each LED lamp 522 is adjusted to a position having a different projecting angle, such that the LED lamp 522 corresponds precisely to each pit 14 of the light transmitting lens 10 to achieve a larger radiating area of the LED lamp set 5.

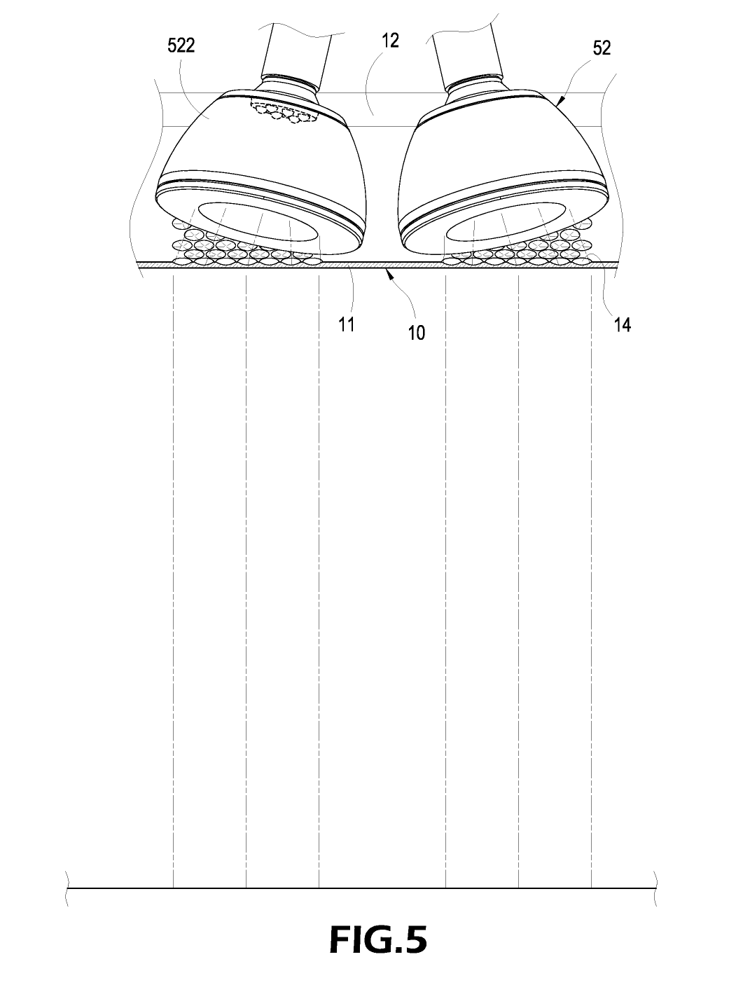

Referring to FIG. 5 for a cross-sectional view of an application of an LED lamp set in accordance with the present invention, the LED lamp set 52 is electrically connected, so that the LED bulb 525 of each LED lamp 522 emits light, and the light is projected through the lens 256 of the LED lamp 522, and then projected to the outside through each pit 14 of the light transmitting lens 10 according to the radiating position of each LED lamp 522, after the light is gathered, so as to improve the directionality of the light of each LED lamp 522 and the even brightness of the projecting area.

In summation of the above description, the LED lamp illumination projecting structure in accordance with the invention herein enhances the performance than the conventional structure and further complies with the patent application requirements.

The present invention are illustrated with reference to the preferred embodiment and not intended to limit the patent scope of the present invention. Various substitutions and modifications have suggested in the forgoing description, and other will occur to those of ordinary skill in the art. Therefore, all such substitutions and modifications are intended to be embraced within the scope of the invention as defined in the appended claims.

What is claimed is:

1. An LED lamp illumination projecting structure comprising:
a casing;
an LED lamp set, installed in the casing, and having a base board fixed in the casing and a plurality of LED lamps coupled to the base board;
a light transmitting lens, installed in an emitting direction of the LED lamp set; and
a plurality of pits formed on an internal side of the light transmitting lens and each pit at a position corresponding to a projecting position of each LED lamp for emitting light of each LED lamp out from the pit after the light is gathered.

2. The LED lamp illumination projecting structure of claim 1, wherein the light transmitting lens is made of a transparent material.

3. The LED lamp illumination projecting structure of claim 1, wherein the light transmitting lens is made of a semi-transparent material.

4. The LED lamp illumination projecting structure of claim 1, wherein the pits are arranged with an interval apart with each other.

5. The LED lamp illumination projecting structure of claim 4, wherein the pit is in a hemispherical shape.

6. The LED lamp illumination projecting structure of claim 1, wherein the light transmitting lens includes a bottom panel and a surrounding panel extended upward from a periphery of the bottom panel.

7. The LED lamp illumination projecting structure of claim 6, wherein the surrounding panel includes a flange extended horizontally outward from a periphery at top of the surrounding panel, and the pits are formed on an internal surface of the bottom panel.
